(19) United States
(12) Patent Application Publication
(10) Pub. No.: US 2026/0010477 A1
(43) Pub. Date: Jan. 8, 2026

(54) SYSTEMS AND METHODS FOR PORT BASED ROUTING FOR SCALABLE MEMORY

(71) Applicant: Samsung Electronics Co., Ltd., Suwon-si (KR)

(72) Inventors: Byung Choi, Fremont, CA (US); Changho Choi, San Jose, CA (US)

(21) Appl. No.: 18/927,442

(22) Filed: Oct. 25, 2024

Related U.S. Application Data
(60) Provisional application No. 63/667,626, filed on Jul. 3, 2024.

(51) Int. Cl. G06F 12/0815; G06F 13/16

(52) U.S. Cl. CPC G06F 12/0815; G06F 13/16; G06F 2212/60

(57) ABSTRACT

A system including: a first memory layer including: a first memory node of a memory pool; and a second memory node of the memory pool, the second memory node being connected to the first memory node by one link in the first memory layer; and a switch to provide access to the first memory node from the second memory node based on: a first identifier corresponding to the first memory layer; and a second identifier corresponding to a location of the first memory node in the memory pool.

### CROSS-REFERENCE TO RELATED APPLICATIONS

The present application claims priority to and the benefit of U.S. Provisional Application No. 63/667,626, filed on July 3, 2024, entitled “COMPUTE EXPRESS LINK (CXL) PORT BASED ROUTING (PBR), PORT-ID (PID) EMBEDDED WITH DIMENSION,” the entire content of which is incorporated by reference herein.

### BACKGROUND

### 1. Field

One or more embodiments of the present disclosure relate to scalable memory, and more particularly, to port based routing for scalable disaggregated memory.

### 2. Description of Related Art

Typically, unlike storage operations in which data is persistently stored in slower, non-volatile memory of storage devices, a computer may perform various operations by accessing data stored in high-speed computer memory. As such, the speed and performance of a computing system may depend on the amount of computer memory resources available to it, and the latencies associated with communications between processing elements and the computer memory resources.

The above information disclosed in this Background section is for enhancement of understanding of the background of the present disclosure, and therefore, it may contain information that does not constitute prior art.

### SUMMARY

Computing systems may run various applications or workloads with different needs for memory. For example, some applications or workloads may require a relatively small amount of memory, while other applications or workloads may require a larger amount of memory. As another example, some applications or workloads may have performance requirements (e.g., desired latency characteristics) with respect to the memory, such as the application or workload may require that the latency of the memory it uses does not exceed a certain amount, while other applications or workloads may be more resilient to such latency concerns.

Some computing systems may include multiple hosts sharing memory, and the total memory thereof may be considered as a memory pool in which the computer memory resources are aggregated together. In other words, a memory pool may act as a whole, rather than as individual memory components. Thus, each of the hosts may interact with the memory pool as a unified memory resource rather than as individual memory components. However, routing communications between disparate memory resources of a memory pool may introduce varying latencies, limiting the ability to increase a coverage span between memory nodes of the memory pool.

Embodiments of the present disclosure may be directed to systems and methods for routing communications between memory nodes of a memory pool based on a cache coherent protocol-based interconnect.

According to one or more embodiments of the present disclosure, a system includes: a first memory layer including: a first memory node of a memory pool; and a second memory node of the memory pool, the second memory node being connected to the first memory node by one link in the first memory layer; and a switch configured to provide access to the first memory node from the second memory node based on: a first identifier corresponding to the first memory layer; and a second identifier corresponding to a location of the first memory node in the memory pool.

In an embodiment, the first identifier may be encoded in first bits of a message received by the switch, and the second identifier may be encoded in second bits of the message received by the switch.

In an embodiment, the first bits and the second bits may be encoded in a header field of the message.

In an embodiment, the first bits of the first identifier may be encoded in at least one of source bits, destination bits, or port bits of the message, or in reserve bits of the message.

In an embodiment, the second identifier may correspond to a port identifier associated with the first memory node.

In an embodiment, the system may further include a second memory layer including a third memory node of the memory pool, the third memory node being connected to the second memory node by one link from the second memory layer to the first memory layer. The switch may be further configured to provide access to the first memory node from the third memory node based on: a third identifier corresponding to the second memory layer; the first identifier corresponding to the first memory layer; and the second identifier corresponding to a location of the first memory node in the memory pool.

In an embodiment, the third memory node may be connected to the first memory node through the second memory node.

In an embodiment, the system may further include a third memory layer including a fourth memory node of the memory pool, the fourth memory node being connected to the third memory node by one link from the third memory layer to the second memory layer, and the switch may be further configured to provide access to the first memory node from the fourth memory node based on: a fourth identifier corresponding to the third memory layer; the third identifier corresponding to the second memory layer; the first identifier corresponding to the first memory layer; and the second identifier corresponding to a location of the first memory node in the memory pool.

In an embodiment, the system may further include a third memory layer including a fourth memory node of the memory pool, the fourth memory node being connected to the third memory node by one link from the third memory layer to the second memory layer, and the fourth memory node may be connected to the first memory node through the third memory node and the second memory node.

According to one or more embodiments of the present disclosure, a method includes: receiving instructions to access a first memory node located in a first memory layer of a memory pool; identifying, from the instructions, a first identifier corresponding to the first memory layer and a second identifier corresponding to a location of the first memory node in the memory pool from a location of a second memory node connected to the first memory node by one link in the first memory layer; and providing access from the second memory node to the first memory node based on the first identifier and the second identifier.

In an embodiment, the first identifier may be encoded in first bits contained in the instructions, and the second identifier may be encoded in second bits contained in the instructions.

In an embodiment, the first bits of the first identifier may be encoded in at least one of source bits, destination bits, or port bits of a header field of the instructions, or encoded in reserve bits of the header field of the instructions.

In an embodiment, the second identifier may correspond to a port identifier associated with the first memory node.

In an embodiment, the method may further include: identifying, from the instructions, a third identifier corresponding to a second memory layer including a third memory node of the memory pool, the third memory node being connected to the second memory node by one link from the second memory layer to the first memory layer; and providing access to the first memory node from the third memory node based on: the third identifier corresponding to the second memory layer; the first identifier corresponding to the first memory layer; and the second identifier corresponding to a location of the first memory node in the memory pool.

In an embodiment, the third memory node may access the first memory node through the second memory node.

In an embodiment, the method may further include: identifying, from the instructions, a third identifier corresponding to a second memory layer including a third memory node of the memory pool, the third memory node being connected to the second memory node by one link from the second memory layer to the first memory layer; identifying, from the instructions, a fourth identifier corresponding to a third memory layer including a fourth memory node of the memory pool, the fourth memory node being connected to the third memory node by one link from the third memory layer to the second memory layer; and providing access to the first memory node from the fourth memory node based on: the fourth identifier corresponding to the third memory layer; the third identifier corresponding to the second memory layer; the first identifier corresponding to the first memory layer; and the second identifier corresponding to a location of the first memory node in the memory pool.

In an embodiment, the fourth memory node may access the first memory node through the third memory node and the second memory node.

According to one or more embodiments of the present disclosure, a system includes: a memory pool; one or more processors connected to the memory pool; and instructions that, when executed by the one or more processors, cause the one or more processors to: receive a command to provide access to a first memory node located in a first memory layer of a memory pool; identify, from the command, a first identifier corresponding to the first memory layer and a second identifier corresponding to a location of the first memory node in the memory pool from a location of a second memory node connected to the first memory node by one link in the first memory layer; and provide access from the second memory node to the first memory node based on the first identifier and the second identifier. The first identifier is encoded in first bits of the command, and the second identifier is encoded in second bits of the command.

In an embodiment, the first bits of the first identifier may be encoded in at least one of source bits, destination bits, or port bits of a header field of the command, or encoded in reserve bits of the header field of the command.

In an embodiment, the second identifier may correspond to a port identifier associated with the first memory node.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 is a block diagram of a disaggregated cache-coherent system according to one or more embodiments of the present disclosure;

FIG. 2 is a schematic diagram of a switching fabric, according to one or more embodiments of the present disclosure;

FIG. 3 is a schematic diagram of a switching fabric, according to one or more embodiments of the present disclosure;

FIG. 4 is a schematic diagram of a switching fabric according to an embodiment of the present disclosure;

FIG. 5A shows a structure of a memory node according to some embodiments of the present disclosure;

FIG. 5B shows a structure of a memory node according to some embodiments of the present disclosure;

FIG. 5C shows a structure of a memory node according to some embodiments of the present disclosure;

FIG. 5D shows a structure of a memory node according to some embodiments of the present disclosure;

FIG. 5E shows a structure of a memory node according to some embodiments of the present disclosure;

FIG. 6A shows a structure of a memory node according to some embodiments of the present disclosure;

FIG. 6B shows a structure of a memory node according to some embodiments of the present disclosure;

FIG. 7 illustrates a plane port ID assignment scheme according to CXL PBR port ID definitions;

FIG. 8 is a block diagram illustrating a port based routing system according to one or more embodiments of the present disclosure;

FIG. 9 illustrates an example of a PBR message based on a CXL protocol;

FIG. 10 is a schematic diagram illustrating an address encoding method in a port based routing system according to one or more embodiments of the present disclosure; and

FIG. 11 illustrates a method of providing access to a first memory node of a memory pool according to one or more embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

Applications or workloads (e.g., clients) running on a host (e.g., a host processor) may have varying requirements for memory, for example, such as in terms of quantity and performance. Moreover, in some computing systems, multiple hosts may be connected to a shared memory pool, such that the requirements of each host (which may be based on the requirements of the applications or workloads running on the host) may differ in terms of the quantity of the memory needed and/or the desired performance (e.g., the desired latency characteristics) of the memory.

A cache coherent protocol-based interconnect, for example, such as a compute express link (CXL) interconnect, is designed to provide a low-latency and high-bandwidth connection between a host processor and other supported devices. For example, CXL is an open industry standard for communications over Peripheral Component Interconnect Express (PCIe), such as PCIe 5.0 and newer versions, which may provide fixed, relatively shorter packet sizes (e.g., FLIT packets and messages). As a result, CXL may be able to provide relatively higher bandwidth and relatively lower latency, and thus, may be suitable for supporting cache coherence and making connections to memory. For example, CXL maintains a unified, coherent memory between the host processor and any memory on the connected CXL device, such that the host processor may be primarily responsible for coherency management. CXL may further be used to provide connectivity between a host and accelerators, memory devices, and network interface circuits (e.g., network interface controllers or network interface cards (NICs)) in a server.

Communications (e.g., messages, packets, and the like) between memory nodes of a memory pool may be routed to each other through a switching circuit (e.g., a switch, a switch controller, or the like, such as a CXL switch) and/or a switching fabric (e.g., a CXL switching fabric). For example, a host may be directly connected to a memory node that may be referred to as a “root memory node,” and other memory nodes of the memory pool may be connected to the host through the root memory node (and, in some cases, through other intermediate memory nodes) via interconnections (e.g., links) of the switching fabric. The communications between the nodes may be routed by the switching circuit based on a mapping. For example, in hierarchical-based routing (HBR), memory nodes at the bottom of the hierarchy typically go up through the host to communicate with each other, even if they are right next to each other. On the other hand, port-based routing (PBR) may allow for more efficient switching by accessing nodes based on a port ID (PID), thereby reducing the number of hops and the associated latency, while enabling more complex topologies.

However, even in the case of CXL PBR, the performance requirements (e.g., the latency characteristics) imposed by some applications or workloads may limit the number of hops to only 1 or 2 hops, thereby limiting the coverage span of the memory nodes of a memory pool. For example, CXL PBR may define PID assignments in a 12-bit, plane, flat manner, which may limit the scaling of the CXL switching cluster due to latency concerns, such as 1 or 2 hops requirements between the memory nodes, as discussed in more detail below.

According to some embodiments of the present disclosure, a scalable, disaggregated memory pool constructed from a multi-dimension array of memory nodes having selectable latencies and/or coverage spans may be provided. Each memory node may be connected to one or more other memory nodes as a memory pool with connections in one or more dimensions, and may be encoded based on a first identifier (e.g., a dimension identifier) and a second identifier (e.g., a node identifier, a port identifier, or the like). The first identifier may indicate the dimension that the node belongs to, and the second identifier may indicate the location of the node within the memory pool. The memory pool may have a characteristic in that the number of hops required to reach a given memory node (and the associated latency) may depend on the location of the memory node in the switching fabric (e.g., a multi-dimension switching fabric) connecting the memory nodes together. For example, in some embodiments, the switching fabric may form a hyper torus. The memory pool may be considered as part of a memory-centric computing system architecture (as distinct from some computing system architectures which may be considered to be a processor-centric computing system architecture).

As such, in some embodiments, an application or workload that has stringent latency requirements may request memory with the lowest latency characteristics (e.g., memory that is in the root memory node). As another example, an application that has somewhat less stringent latency requirements may request memory that is in a set of memory nodes that can be reached within one hop (e.g., one link) from the root memory node (e.g., memory that is in the first dimension). As another example, applications with even less stringent latency requirements may use memory that is in a set of memory nodes reachable from the root memory node by even a larger number of hops or links (e.g., memory that is in the second dimension or the third dimension).

Accordingly, in some embodiments, Memory as a Service (MaaS) may be provided, in which a hop control based latency management capability could be used as seed information that a content service provider (CSP) can use to create memory services based on service level agreements (SLAs) for users. For example, a memory service with level A may charge more money than a memory service with level B, in which level A has less latency (e.g., a lesser number of hops) to access the memory resources therein than that of level B. As another example, level A may have more memory resources available, albeit requiring a larger number of hops to access all of the memory resources therein, than that of level B.

According to some embodiments, as the dimensionality of the memory pool increases, the coverage span of the memory pool may be increased. However, in this case, the latency for accessing some of the memory nodes in the memory pool may also be increased. For example, each of the memory nodes located in adjacent dimensions or layers may be accessed within 1 or 2 hops from each other, while memory nodes located in more distant dimensions or layers may be accessed within 3 or even more hops (e.g., as the dimensions or layers become more distant from each other). As such, in some embodiments, an application or workload needing more memory resources may request memory in increasingly higher dimensions with a correspondingly increase in the number of hops.

The above and/or other aspects and features of the present disclosure will now be described in more detail hereinafter with reference to the figures. While one or more embodiments of the present disclosure may be described in more detail hereinafter in the context of CXL memory and CXL interfaces and interconnects, the present disclosure is not limited thereto, and the memory may be any suitable kind of scalable memory that is connected via any suitable kind of interface or interconnects, for example, such as NVLink/Nvidia based memory pooling.

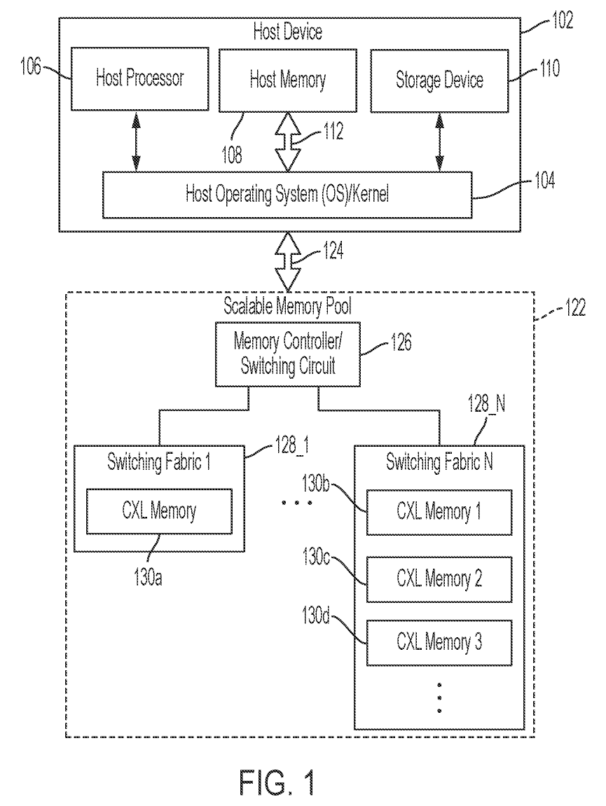

FIG. 1 is a block diagram of a disaggregated cache-coherent system according to one or more embodiments of the present disclosure.

Referring to FIG. 1, a host device 102 may include an operating system/kernel 104, a host processor 106, host memory 108, and a storage device 110. The operating system/kernel 104 may include system software to provide an interface between hardware and a user, and between software applications and the hardware. For example, the operating system/kernel 104 may be configured for resource allocation, memory management, CPU management, file management, execution of processes, and/or the like for the host device 102. For example, in some embodiments, the operating system/kernel 104 may include a Linux operating system/kernel, but the present disclosure is not limited thereto, and the operating system/kernel 104 may include any suitable operating system/kernel as would be known to those skilled in the art, such as a Windows OS, an Apple OS (e.g., macOS), a Chrome OS, and the like.

The host processor 106 may be a processing circuit, for example, such as a general-purpose processor or a central processing unit (CPU) core of the host device 102. The host processor 106 may be connected to other components via an address bus, a control bus, a data bus, and/or the like. The host processor 106 may execute instructions stored in the host memory 108 to perform the various operations described herein. For example, the host processor 106 may execute one or more system processes and background processes (which are described in more detail below), which may be copied from persistent storage (e.g., the storage device 110, read-only memory (ROM), and/or the like) to the host memory 108 as needed or desired (e.g., at startup, execution time, interrupt routine, and/or the like).

The host memory 108 may be considered as high performing main memory (e.g., primary memory) of the host device 102. For example, in some embodiments, the host memory 108 may include (or may be) volatile memory, such as dynamic random-access memory (DRAM) that may be directly connected to a memory slot of a motherboard of the host device 102 via a first memory interface 112. In this case, the first memory interface 112 (e.g., the connector and the protocol thereof) may include (or may conform to) dual in-line memory module (DIMM) to facilitate communications between the host memory 108 and the host processor 106 (e.g., via the host OS/kernel 104), such that the host memory 108 may be the DIMM memory connected to the DIMM slot of the host device 102. However, the present disclosure is not limited thereto, and the host memory 108 may include (or may be) any suitable high performing main memory (e.g., primary memory) replacement for the host device 102 as would be known to those skilled in the art. For example, in other embodiments, the host memory 108 may be relatively high performing non-volatile memory, such as NAND flash memory, Phase Change Memory (PCM), Resistive RAM, Spin-transfer Torque RAM (STTRAM), any suitable memory based on PCM technology, memristor technology, and/or resistive random access memory (ReRAM), and may include, for example, chalcogenides, and/or the like.

The storage device 110 may be considered as secondary memory (e.g., secondary storage) that may persistently store data accessible by the host device 102. In this context, the storage device 110 may include (or may be) relatively slower memory when compared to the high performing main memory of the host memory 108. For example, in some embodiments, the storage device 110 may be a Solid-State Drive (SSD). However, the present disclosure is not limited thereto, and in other embodiments, the storage device 110 may include (or may be) any suitable storage device, for example, such as a magnetic storage device (e.g., a hard disk drive (HDD), and the like), an optical storage device (e.g., a Blu-ray disc drive, a compact disc (CD) drive, a digital versatile disc (DVD) drive, and the like), other kinds of flash memory devices (e.g., a USB flash drive, and the like), and/or the like. In various embodiments, the storage device 110 may conform to a large form factor standard (e.g., a 3.5-inch hard drive form-factor), a small form factor standard (e.g., a 2.5 inch hard drive form-factor), an M.2 form factor, an E1.S form factor, and/or the like. In other embodiments, the storage device 110 may conform to any suitable or desired derivative of these form factors.

The storage device 110 may be connected to the host processor 106 via a storage interface. The storage interface may facilitate communications (e.g., using a connector and a protocol) between the host processor 106 and the storage device 110 (e.g., via the host OS/kernel 104). In some embodiments, the storage interface may facilitate the exchange of storage requests and responses between the host processor 106 and the storage device 110. In some embodiments, the storage interface may facilitate data transfers by the storage device 110 to and from the host memory 108 of the host device 102. For example, in various embodiments, the storage interface (e.g., the connector and the protocol thereof) may include (or may conform to) Small Computer System Interface (SCSI), Non Volatile Memory Express (NVMe), Peripheral Component Interconnect Express (PCIe), remote direct memory access (RDMA) over Ethernet, Serial Advanced Technology Attachment (SATA), Fiber Channel, Serial Attached SCSI (SAS), NVMe over Fabric (NVMe-oF), and/or the like. In other embodiments, the storage interface (e.g., the connector and the protocol thereof) may include (or may conform to) various general-purpose interfaces, for example, such as Ethernet, Universal Serial Bus (USB), and/or the like.

Still referring to FIG. 1, the host device 102 is connected to a scalable memory pool 122 via a second memory interface 124 different from the first memory interface 112. The scalable memory pool 122 may include a memory controller/switching circuit 126, one or more switching fabrics 128_1 to 128_N (where N is a natural number), and one or more scalable memory devices 130a, 130b, 130c, and 130d, for example, such as one or more compute express link (CXL) memory devices. The scalable memory devices 130a, 130b, 130c, and 130d may be connected to one another via interconnections (e.g., links) in the one or more switching fabrics 128_1 to 128_N. In some embodiments, the scalable memory pool 122 may be a disaggregated CXL memory pool including a plurality of different types of CXL memory devices 130a, 130b, 130c, and 130d, which may typically include volatile memory such as DRAM, for example, from among DDR3, DDR4, DDR5, low-power, high-power, low-profile, PMEM, HBM, SSD with DRAM, and/or the like. However, the present disclosure is not limited thereto, and the scalable memory pool 122 may include (or may be) any suitable high performing scalable memory for the host device 102 as would be known to those skilled in the art, similar to the examples described above for the host memory 108.

The one or more switching fabrics 128_1 to 128_N may forward flit-sized packets (64-byte packets), or “cell-sized” packets that are smaller than 64 bytes, to reduce latency. The memory controller/switching circuit 126 may maintain a mapping (e.g., a mapping table), and may perform access control and path management (e.g., selecting between a hardware path and a software path, when data access is performed). The selecting may be performed based on the kind of workload (e.g., based on whether it is latency sensitive), with a faster path being more appropriate, in some cases, when the workload is latency sensitive.

For example, when a host (e.g., a client, an application, a workload, or the like running on the host) performs a read or write operation, the memory controller/switching circuit 126 may select the shortest path (the path having the fewest hops) through the switching fabrics 128_1 to 128_N. The selection may be based on topology information stored (e.g., programmed, when the switching fabric is first constructed or upon a host command) in the memory controller/switching circuit 126. For example, the memory controller/switching circuit 126 may store a lookup table storing a suitable route for accessing each node based on a first indicator (e.g., a dimension indicator) and a second indicator (e.g., a node indicator, a port indicator, and/or the like) defined for each of the nodes, which will be described in more detail below.

In FIG. 1, the second memory interface 124 (e.g., the connector and the protocol thereof) may include (e.g., may conform to) a cache coherent protocol-based interconnect, such as a CXL interconnect, as part of the one or more switching fabrics 128_1 to 128_N. For example, in some embodiments, the cache coherent protocol-based interconnect may be built on a serial interface, such as periphery component interconnect express (PCIe), to facilitate communications between the host device 102 and the memory devices 130a, 130b, 130c, and 130d of the scalable memory pool 122 (e.g., via the host OS/kernel 104). In this case, each of the memory devices 130a, 130b, 130c, and 130d may be connected to a PCIe slot of the host device 102 as a PCIe device. However, the present disclosure is not limited thereto, and the second memory interface 124 may include Ethernet links, Ultra Ethernet links (UE Links), Ultra Accelerator Links (UALinks), or any other suitable (e.g., electrical, optical, or wireless) high speed links.

The switching fabrics 128_1 to 128_N may be connected to each other by, for example, CXL links (e.g., UALinks) or Ethernet links (e.g., UE Links), or any other suitable (e.g., electrical, optical, or wireless) high speed links. The links between the memory controller/switching circuit 126 and the switching fabrics 128_1 to 128_N may be for example, CXL links or Ethernet links, or any other suitable (electrical, optical, or wireless) high speed links.

In some embodiments, the scalable memory pool 122 may be a network attached scalable memory pool. In some such embodiments, the scalable memory pool 122 may be connected to the host device 102 via the memory controller/switching circuit 126 and/or a network interface controller (NIC). Further, the host device 102 may use the memory controller/switching circuit 126 and/or the NIC to communicate with the scalable memory pool 122 over a suitable communications network (e.g., the Internet, a wide area network, a local area network, a cellular network, and/or the like) or a suitable Ethernet link in a network attached scalable memory pool case.

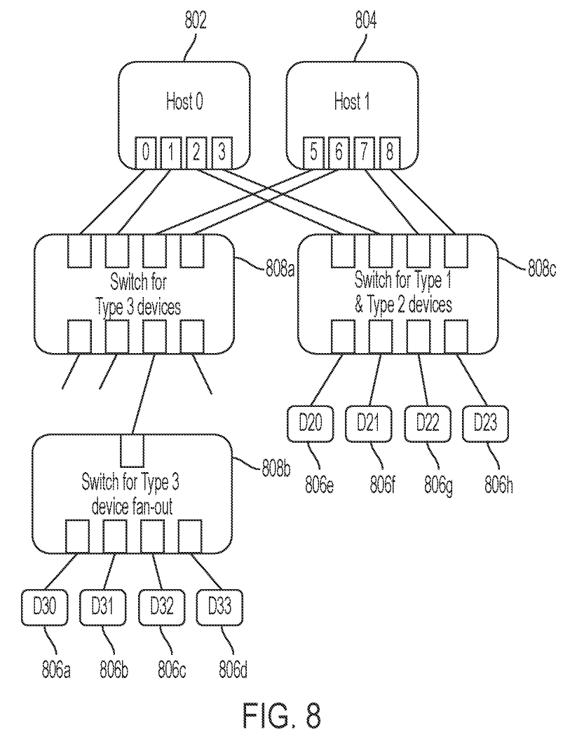

While FIG. 1 shows an example of one host device 102 connected to the scalable memory pool 122, the present disclosure is not limited thereto, and a plurality of host devices 102 may be connected to the scalable memory pool 122, for example, as shown in FIG. 8.

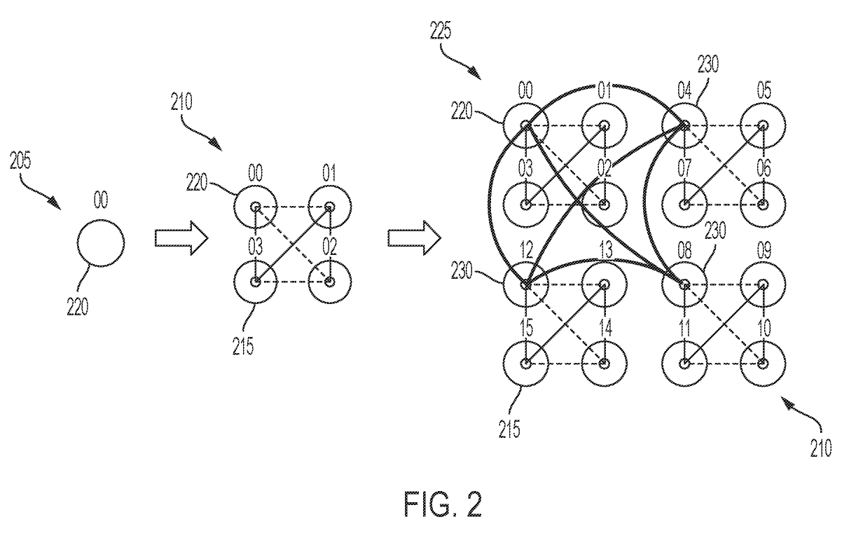

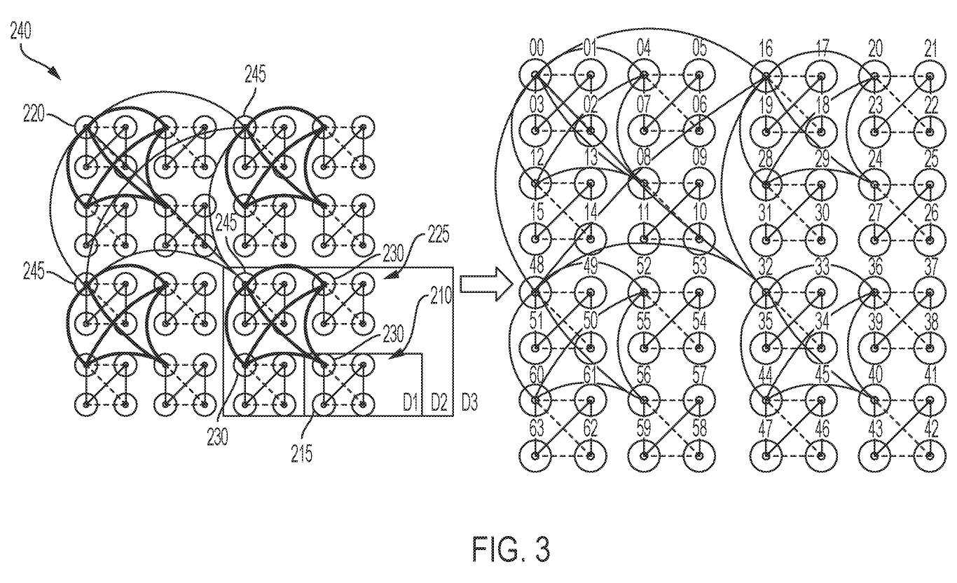

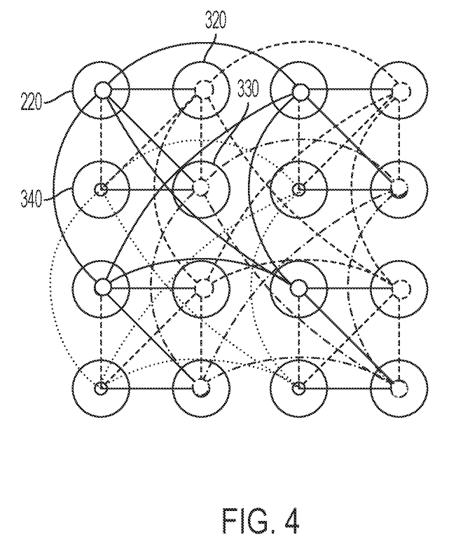

FIG. 2 is a schematic diagram of a switching fabric, according to one or more embodiments of the present disclosure. FIG. 3 is a schematic diagram of a switching fabric, according to one or more embodiments of the present disclosure. FIG. 4 is a schematic diagram of a switching fabric according to an embodiment of the present disclosure. For example, FIGS. 2 and 3 may show a progression of a series of memory pools of increasing dimension.

Referring to FIG. 2, a memory pool of a zero-dimension layer 205 may include a single memory node 220, and thus, may be a root memory node (discussed in more detail below). A memory pool in a one-dimension layer 210 may include a fully-connected cluster (or “cell”) of memory nodes 215 (e.g., four memory nodes 215 shown as a representative example), one of which may be a root memory node 220 (e.g., through which the host may form a connection to all of the memory nodes of the memory pool), and may form a one-dimensional hyper torus. In this case, the root memory node 220 of the one-dimension layer 210 may be connected to each of the other memory nodes 215 of the one-dimension layer 210 by one hop or link (e.g., via the switching fabric).

A memory pool in the form of a two-dimension layer 225 may include a plurality of one-dimension layers 210, each including a fully-connected cluster (or “cell”) of memory nodes 215. The root memory node 220 of the two-dimension layer 225 may be fully connected to at least one node 230 in each of the one-dimension layers 210. In other words, the root memory node 220 of the two-dimension layer 225 may be connected to the at least one node 230 in each of the one-dimension layers 210 by one hop or link (e.g., via the switching fabric). As such, the root memory node 220 of the two-dimension layer 225 may be connected to a memory node 230 from among the fully-connected cluster of memory nodes 215 of each of the one-dimension layers 210 by one hop or link, and may be further connected to the other memory nodes 215 of each of the one-dimension layers 210 of the two-dimension layer 225 by two hops or links (e.g., by one more hop or link from the connected node 230). For example, in some embodiments, the at least one node 230 may be the root memory node 220 of the corresponding one-dimension layer 210, but the present disclosure is not limited thereto, and the at least one node 230 may be a source node, a destination node, or the like.

In other words, when the one-dimension layer 210 has 4 nodes with full mesh driven interconnections, the two-dimension layer 225 may include 4 one-dimension layers 210 that have full mesh interconnections at a high level. When considering one of the 4 one-dimension layers 210 as one big node, the two-dimension layer 225 has 4 of these big nodes, each being a one-dimension layer 210, and forms a full mesh connection for the two-dimension layer 225 level. In more detail, each node in the one-dimension layer 210 has a full mesh interconnection as shown in FIG. 2, so that there are 4 full mesh interconnection masks for each of the 4 nodes of the one-dimension layer 210 of the two-dimension layer 225 to form a two-dimension layer 225 hyper torus full mesh interconnections cluster. For example, FIG. 4 shows the total interconnections to form up to a two-dimension layer 225 level hyper torus full mesh. This can be continued to be scaled in higher dimension hyper torus full mesh clusters in the same or substantially the same way, and there may be no limit to the growth.

For example, referring to FIG. 3, a memory pool in the form of a three-dimension layer 240 may include a plurality of two-dimension layers 225, each including a plurality of one-dimension layers 210, each including a fully-connected cluster (or “cell”) of memory nodes 215. The root memory node 220 of the three-dimension layer 240 may be fully connected to at least one node 245 in each of the two-dimension layers 225 of the three-dimension layer 240 (e.g., via the switching fabric). The at least one node 245 of each of the two-dimension layers 225 may be fully connected to at least one node 230 in each of the one-dimension layers 210 of the corresponding two-dimension layer 225 (e.g., via the switching fabric). In other words, the root memory node 220 of the three-dimension layer 240 may by connected to the at least one node 245 in each of the two-dimension layers 225 by one hop or link, the at least one node 245 of each of the two-dimension layers 225 may be connected to the at least one node 230 in each of the one-dimension layers 210 of the corresponding two-dimension layer 225 by one hop or link, and the at least one node 230 of each of the one-dimension layers 210 may be connected to each of the other nodes 215 of the corresponding one-dimension layer 210 by one hop or link.

As such, the root memory node 220 of the three-dimension layer 240 may be connected to a memory node 245 of each of the two-dimension layers 225 by one hop or link, may be further connected to a memory node 230 of each of the one-dimension layers 210 by two hops or links (e.g., by one more hop or link from the connected node 245 of the two-dimension layer 225), and may be further connected to each of the fully-connected cluster of memory nodes 215 of each of the one-dimension layers 210 by three hops or links (e.g., by one more hop or link from the connected node 230 of the corresponding one-dimension layer 210). For example, in some embodiments, the at least one node 230 may be the root memory node 220 of the corresponding one-dimension layer 210, and the at least one node 245 may be the root memory node 220 of the corresponding two-dimension layer 225, but the present disclosure is not limited thereto, and the at least one nodes 230 and 245 may each be a source node, a destination node, or the like.

In other words, the three-dimension layer 240 cluster may be formed by 4 of the two-dimension layer 225 clusters. When considering a two-dimension layer 225 cluster, which has 16 nodes, as one big node (B2Node), the three-dimension layer 240 cluster is formed with 4 B2Nodes, and thus, has 64 nodes (e.g., 4 of the 16 node clusters of the 4 two-dimension layer 225 clusters). The 4 B2Nodes have a full mesh interconnection to form a three-dimension layer 240 level hyper torus full mesh. In other words, as shown in FIG. 3, the three-dimension layer 240 level hyper torus full mesh may include 16 full mesh interconnection masks for each of the 16 nodes in the two-dimension layer 225 level to form the three-dimension layer 240 cluster with the hyper torus full mesh interconnections. Accordingly, depending on a desired quantity of memory and a desired performance (e.g., latency characteristics), a suitably dimensioned memory pool with suitable performance characteristics may be formed or selected.

For example, the suitably dimensioned memory pool may be pre-configured, may be dynamically configured, or may be configured based on a command (e.g., a host command) or command protocol (e.g., CXL.io, CXL.cache, CXL.mem, or the like). As an example, the CXL transaction layer may include three multiplexed sub-protocols that run concurrently or substantially simultaneously on a single link, and may be referred to as CXL.io, CXL.cache, and CXL.memory. CXL.io may include I/O semantics, which may be similar to PCIe. CXL.cache may include caching semantics, and CXL.memory may include memory semantics. Further, Gen-Z protocol worked on for memory semantics and OpenCAPI protocol worked on for caching semantics may be folded into CXL as a part of the CXL protocols.

While FIGS. 2 and 3 show four memory nodes in the fully-connected cluster (or “cell”) of memory nodes 215 in the one-dimension layer 210, the present disclosure is not limited thereto. For example, the number of memory nodes in the fully-connected cluster of the one-dimension layer 210 may be variously modified as needed or desired, for example, depending on a number of links available between the nodes, a desired size of the fully-connected cluster of memory nodes 215, design requirements, and/or the like. In some embodiments, each dimension may be scaled in an order of a power of the number of nodes located in the fully-connected cluster of memory nodes 215 in the one-dimension layer 210. For example, when the one-dimension layer 210 includes 3 fully connected memory nodes 215 (including the root node 220), the second dimension 225 may include 3 one-dimension layers 210 (each including 3 fully connected memory nodes 215), and the third dimension 240 may include 3 two-dimension layers 225 (each including 3 one-dimension layers 210). Further, the progression illustrated in FIGS. 2 and 3 may be extended to construct a hyper torus with an arbitrarily large number of dimensions. As used herein, a “hyper torus” with dimension N and cell size M is a set of M^{N} connected nodes that are fully connected along each of the N dimensions and that include a root node connected to M-1 other nodes in each of the N dimensions.

In FIGS. 2 and 3, each memory node may be connected to the switching fabric through a cache coherent protocol-based interconnect, such as a CXL connection. In this case, each memory node may include one or more memory modules. The memory modules may be connected together by CXL connections, and each memory module may be configured as a CXL single logical device (SLD) or as multiple logical devices (MLD).

While FIGS. 2 and 3 illustrate the full connections between the respective nodes based on one root node 220, the present disclosure is not limited thereto. For example, as shown in FIG. 4, in some embodiments, each of the nodes may be a root node (e.g., a node through which the other nodes are connected to a host), a source node (e.g., a node containing requested data, a source of a message, and the like), a destination node (e.g., a node requesting the data, a destination of a message, and the like), or the like, that is fully connected to at least one root node, source node, destination node, or the like in each of the other dimensions. For example, in some embodiments, as shown in FIG. 4, a first root node 220 of the two-dimension layer may be fully connected to one node in each of the one-dimension layers of the two-dimension layer, a second root node 320 of the two-dimension layer may be fully connected to another node in each of the one-dimension layers of the two-dimension layer, a third root node 330 of the two-dimension layer may be fully connected to another node in each of the one-dimension layers of the two-dimension layers, and a fourth root node 340 of the two-dimension layer may be fully connected to another node in each of the one-dimension layers of the two-dimension layers. In this case, any other node in the two-dimension layer may be reached within 1 or 2 hops or links from any node in a root one-dimension layer (e.g., the one-dimension layer containing the root nodes of the two-dimension layer).

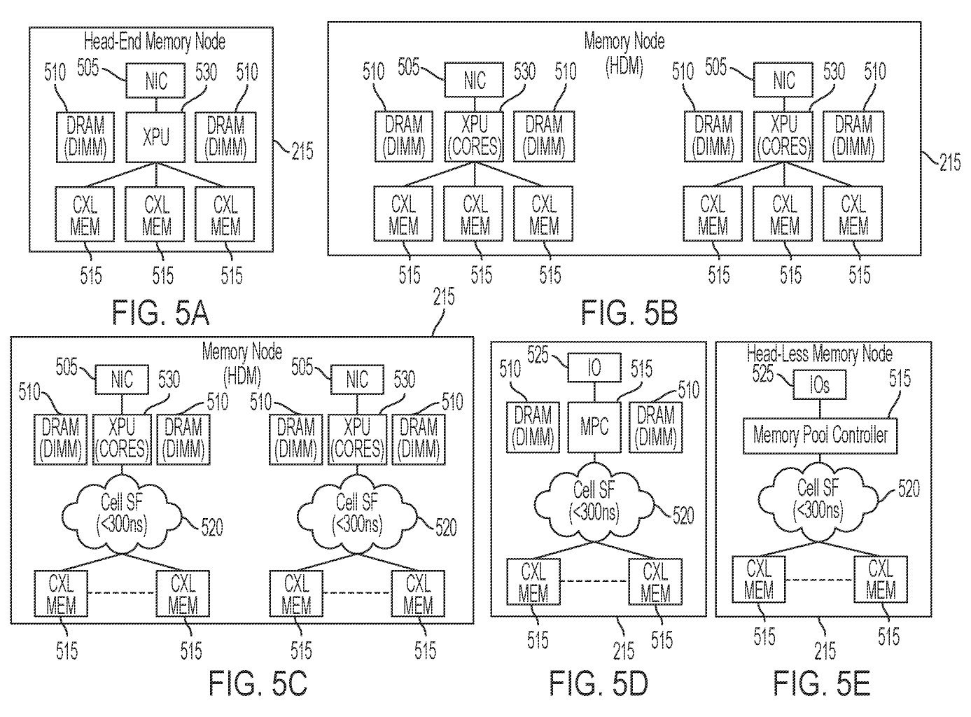

FIG. 5A shows a structure of a memory node according to some embodiments of the present disclosure. FIG. 5B shows a structure of a memory node according to some embodiments of the present disclosure. FIG. 5C shows a structure of a memory node according to some embodiments of the present disclosure. FIG. 5D shows a structure of a memory node according to some embodiments of the present disclosure. FIG. 5E shows a structure of a memory node according to some embodiments of the present disclosure.

Referring to FIGS. 5A through 5E a memory node 215 is shown according to some embodiments. FIG. 5A shows a head-end memory node, which includes a network interface circuit (NIC) 505, a computational processing circuit 530, node memory (e.g., DRAM memory) 510, and pool memory 515. The node memory 510 may include DRAM memory, which may be in a dual inline memory module (DIMM) package with a double data rate interface. In other embodiments, the node memory 510 includes high bandwidth memory (HBM). As used herein, a “computational processing circuit” is any stored-program computer circuit (e.g., a central processing unit, graphics processing unit, neural processing unit, or tensor processing unit), or a stored program computer implemented in an application-specific integrated circuit, a field programmable gate array, and/or the like. The node memory 510 may be used by the computational processing circuit 530 (e.g., to store instructions executed by the computational processing circuit 530 or to store data used by the computational processing circuit 530).

The pool memory 515 may be memory that contributes to the memory pool, and is used to store data for clients (e.g., applications, workloads, or the like running on a host). For example, the pool memory 515 may be CXL memory, but the present disclosure is not limited thereto, and the pool memory 515 may be any suitable disaggregated memory. For example, the pool memory 15 may be volatile or persistent memory (e.g., NAND flash memory or zNAND memory). In a head-end node, connections between the computational processing circuit 530 and the node memory 510 may be a double data rate (DDR) connection. The connection between the computational processing circuit 530 and the pool memory 515 may be PCIe/CXL.io. The connection between the computational processing circuit 530 and the NIC 505 may be PCIe/CXL.io or Ethernet. The embodiment illustrated in FIG. 5A may exhibit relatively low latency.

FIG. 5B shows a memory node structure similar to that described above with reference to FIG. 5A, except that the structure illustrated in FIG. 5B includes two co-packaged computational processing circuits 530 (which may be part of a composite computational processing circuit, for example, such that each of the two computational processing circuits 530 may be installed in a respective socket of two closely spaced sockets in a printed circuit board or substrate). The co-packaged computational processing circuits 530 may be configured to communicate directly with each other through a high-speed interface (e.g., such as an Ultra Path Interconnect (UPI)). In some embodiments, more than two co-packaged computational processing circuits 530 may be present (e.g., each in a respective socket).

Each of the embodiments illustrated in FIGS. 5C, 5D, and 5E includes a cell switching fabric 520, which may include multiple switching fabrics interconnected through switching fabric links. FIG. 5C shows a structure in which the pool memories 515 are connected together and are connected to the computational processing circuits 530 by a cell switching fabric 520. Unlike that described above with reference to FIGS. 5A through 5C, which show a head-end memory node that includes a computational processing circuit 530, such that the memory node may be capable of providing data access through remote direct memory access, the embodiments illustrated in FIGS. 5D and 5E show structures of “headless” memory nodes according to some embodiments. The memory nodes may be referred to as headless, because each of the memory nodes may lack a computational processing circuit 530. An input-output connector 525 (e.g., including a set of conductors) may be used to form connections to other memory nodes within the multi-dimension switching fabric 520. The structure illustrated in FIG. 5E may lack the node memory (e.g., DRAM memory) 510, which is present in the structure illustrated in FIG. 5D to be employed by the memory pool controller 515. The embodiments illustrated in FIGS. 5A and 5B, which may show a direct attached architecture between the XPU and the memory (e.g., DRAM, CXL MEM, or the like), may exhibit relatively lower latency compared to those of the embodiments illustrated in FIGS. 5C through 5E, which may show a fabric attached architecture.

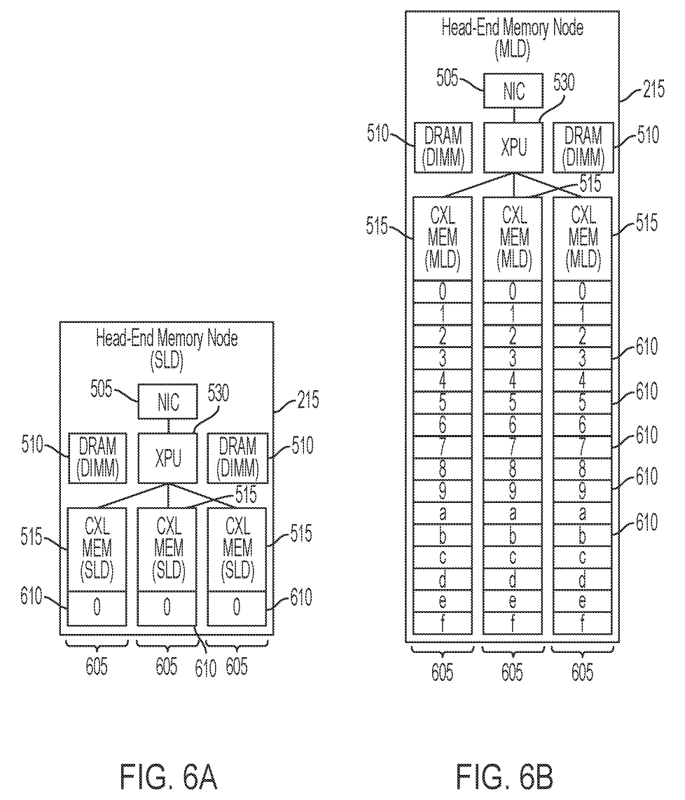

FIG. 6A shows a structure of a memory node according to some embodiments of the present disclosure. FIG. 6B shows a structure of a memory node according to some embodiments of the present disclosure. FIGS. 6A and 6B show various embodiments of some possible structures of a memory node design based on open standard CXL specifications. FIG. 6A shows a case of a single logical device (SLD) memory expander, and FIG. 6B shows a case of a multiple logical device (MLD) memory expander that has a single physical interface, but internally could form a maximum of 16 logical devices and can map to a maximum of 16 hosts, respectively.

FIGS. 6A and 6B show some structures for head-end memory nodes 215. As illustrated in FIG. 6A, in some embodiments, a head-end memory node 215 may include a plurality of memory modules 605. Each of the plurality of memory modules 605 may include pool memory 515, and may be configured as a single logical device. As illustrated in FIG. 6B, in some embodiments, a head-end memory node 215 may include a plurality of memory modules 605, each configured as multiple logical devices 610. Each of the multiple logical devices 610 may be assigned to a respective client (e.g., an application, a workload, or the like running on a host processor).

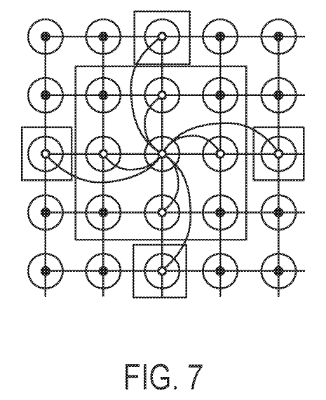

FIG. 7 illustrates a plane port ID assignment scheme according to CXL PBR port ID definitions.

Referring to FIG. 7, the topologies available in CXL PBR based on port ID (PID) assignments may be limited by the number of hops or links it may take to span the memory nodes. For example, while CXL allows for 12-bits for port ID assignments, allowing for up to 4096 nodes, when limited to only one or two hops or links, the coverage area span may include only 9 nodes as shown in FIG. 7.

On the other hand, as discussed in more detail below, when dimension information is provided for each of the memory nodes, even when limited to only one or two hops or links, the coverage area span may include 16 nodes (e.g., in the two-dimension layer) as shown in FIGS. 2 through 4. As such, the coverage area span may be dramatically improved, and thus, more memory resources may be accessible within the same latency (e.g., 1 or 2 hops or links).

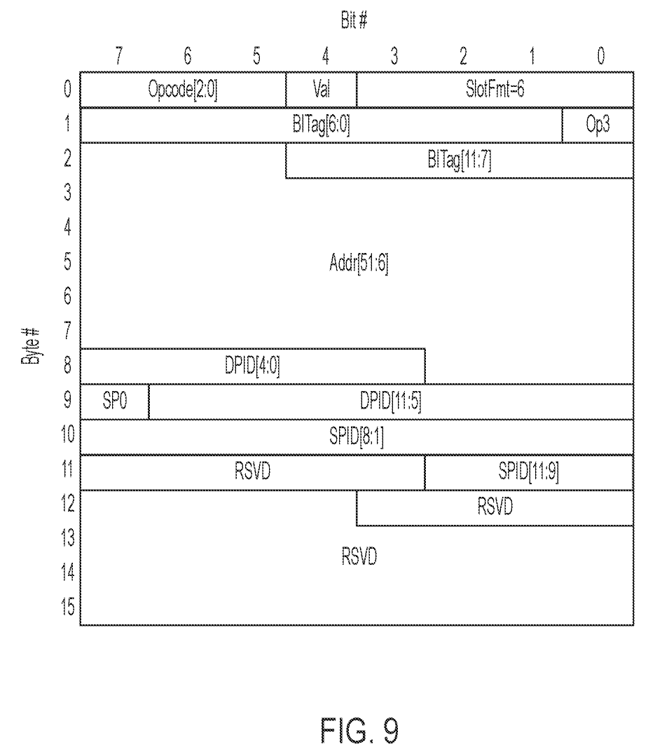

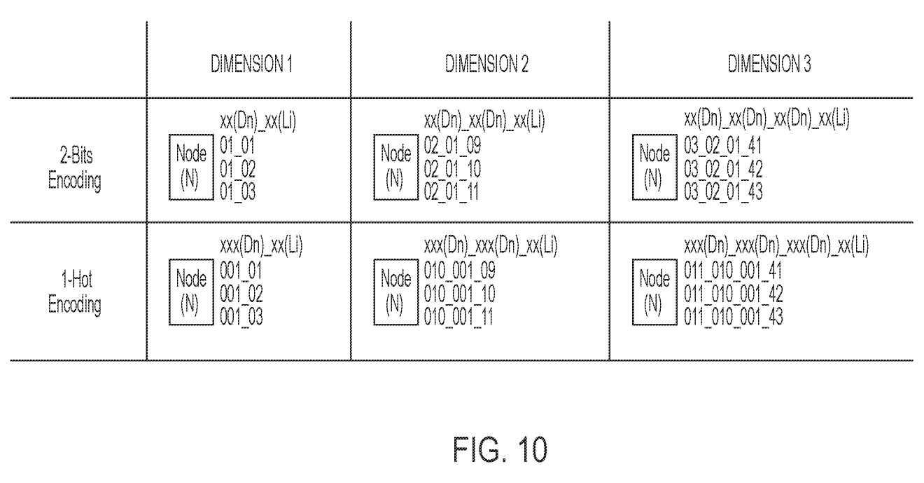

FIG. 8 is a block diagram illustrating a port based routing system according to one or more embodiments of the present disclosure. FIG. 9 illustrates an example of a PBR message based on a CXL protocol. FIG. 10 is a schematic diagram illustrating an address encoding method in a port based routing system according to one or more embodiments of the present disclosure.

Referring to FIG. 8, in some embodiments, a PBR system may include a plurality of host devices 802 and 804, each the same or substantially the same as (or similar to) the host device 102 described above with reference to FIG. 1. The host devices 802 and 804 may be connected to a plurality of connected devices 806a to 806h (e.g., CXL devices) of various types (e.g., type 1, 2, 3 CXL devices) through one or more corresponding switches 808a to 808c (e.g., CXL switches based on the CXL device types). In this case, according to some embodiments, port IDs (PIDs) may be assigned to the ports of the connected devices 806a to 806h and to the ports of the host devices 802 and 804, each corresponding to a client, application, or workload, but not to the ports of the switches 808a to 808c. However, the present disclosure is not limited thereto, and in some embodiments, the PIDS may also be assigned to the ports of the switches 808a to 808c in addition to, or instead of, the ports of the host devices 802 and 804 and/or the connected devices 806a to 806h.

In more detail, the role of the switches 808a to 808c may generally be for forwarding incoming messages from ingress ports to egress ports based on a flow table on the switch. There are two kinds of switches in CXL, an HBR (hierarchy based routing) switch and a PBR (port based routing) switch. HBR Switch is based on the PCIe/CXL.io standard, which is a strict ordering rule-based protocol. The only difference between PCIe and CXL.io is the payload size for the message. The payload for PCIe is variable while CXL.io is fixed to 64 Bytes, called a FLIT. It should be noted, however, that PCI-SIG adopted 64 Bytes FLIT Mode from PCIe Gen 6 and higher specifications. CXL provides the PBR capability by adding 12bits space/field for source ID and destination ID in message header top of HBR, and making it available for a new PBR capability for host and devices (e.g., Switches and type 1/2/3 devices). Because the PBR switch already includes HBR features, PBR == HBR + SPID (12bits)/DPID (12bits), where SPID is the Source Port ID and DPID is the Destination Port ID.

In CXL PBR, the PIDs are defined in a plane, flat manner, such that the resulting topology of the memory nodes is in a plane, flat manner (e.g., see FIG. 7). For example, in CXL PBR, the PIDs may be assigned in 12-bits each for source and destination (or 6-bits each for source and destination depending on versions), such that source IDs (SPID) may be assigned in ascending order from 0 to 4095 (e.g., 0000_0000_0000 to 1111_1111_1111), and destination IDs (DPID) as well. In this case, however, when limited to 1 or 2 hops or links latency, the coverage area span may be reduced as well, for example, as discussed above with reference to FIG. 7

According to some embodiments of the present disclosure discussed above, the memory nodes may be connected to each other in multi-dimensions or layers, such that the memory nodes may be encoded (e.g., address encoded) based on a first indicator (e.g., dimension information) and a second indicator (e.g., node location information, node index, or the like), which may be extended from CXL PBR.

For example, in some embodiments, a bit encoding method may be used, the number of bits thereof being based on the number of nodes in the fully-connected cluster (or “cell”) of memory nodes 215 in the one-dimension layer 210. For example, when the one-dimension layer 210 includes 4 nodes, such that 3 links are required for each node to fully connect them, a 2-bit encoding logic method may be used, in which the dimension information is encoded in 2-bits each (e.g., D4_D3_D2_D1 = xx_xx_xx_xx). In this case, the memory controller/switching circuit 126 may include suitable logic (e.g., software/firmware and/or hardware) to analyze the bit positions of the encoded dimension information for the path selection, message exchange, packet exchange, and the like.

In some embodiments, a hot encoding (e.g., 1-hot encoding) method (e.g., D4_D3_D2_D1 = xxx_xxx_xxx_xxx) may be used. For example, in this case, some logic or circuit may be included to simply determine whether or not the port associated with the memory node is active or not (e.g., is hot or not), such that for each corresponding bit status, the message can be automatically routed. The hot encoding (e.g., 1-hot encoding) method may represent the relationship between hardware and software as a 1:1 mapping in which there is no additional logic required to comprehend the hardware status. For example, when each node requires 3 links to form the full mesh connections, and when software/firmware reads the 3 physical links, if hot encoding is used, there is no additional processing required. Instead, three bits are used for each dimension’s link monitoring, and a determination of whether or not an action is required may be based on an On/Off status of the bit that represents the particular link. On the other hand, if the 2-bit encoding logic method is used, a two-step processing may be used to 1) read the 2-bit status, and 2) parse the status (e.g., 0, 1, 2, 3) to determine the corresponding link. In any event, the 2-bit encoding or the hot encoding method may be used according to a desired design, how the clusters are implemented (e.g., larger or smaller clusters), and the like.

In some embodiments, in the bit encoding method and the hot encoding method, the SPID and the DPID in the header field of a PBR message may be used for the respective encoding. As an example, as shown in FIG. 9, the SPID and DPID bits in the header field of an S2M BISnp message based on CXL.mem may be used for encoding the bits for the dimension information. As another example, corresponding bits of a FLIT packet (e.g., in the FLIT header field) or the like may be used for encoding the dimension information.

However, the present disclosure is not limited thereto, and an encoding method (e.g., a bit encoding method or a hot encoding method) in which additional bits (e.g., D6_D5_D4_D3_D2_D1 = xx_xx_xx_xx_xx_xx) may be used for the dimension information in addition to the 12-bit PIDs (e.g., xxxx_xxxx_xxxx), for example, in the case of a 24-bits bitmap (e.g., xx_xx_xx_xx_xx_xx__xxxx_xxx_xxxx). As an example, as shown in FIG. 9, the reserve bits RSVD in the header field may be used for encoding the bits for the dimension information. As another example, corresponding bits of a FLIT packet (e.g., reserve bits in the FLIT header field) or the like may be used for encoding the dimension information.

For some illustrative examples, assuming that an Nth node (e.g., see FIG. 10) is the root node (e.g., 220 in FIGS. 2 and 3), the three links to the other three nodes from the Nth node may be defined by 2-bits for each dimension in the first indicator xx(Dn) (e.g., the dimension information), and 2-bits for each node location (e.g., for each node index) in the second indicator xx(Li) (e.g., the node indicator, the port indicator, or the like).

For example, for convenience of illustration, the node index for the nodes in each of the one-dimension layer 210, the two dimension-layer 225, and the three-dimension layer 240 may be assumed to start at 0 (e.g., 00), and may grow clock-wise for a full mesh, as shown in FIGS. 2 and 3, but the present disclosure is not limited thereto, and the actual values of the node index for each of the nodes may be implementation specific. However, based on the illustrative example shown in the figures, as shown in FIGS. 2 and 10, from the root node 220 (e.g., having a node index of 00) in the one-dimension layer 210, the other three linked nodes 215 may each be encoded by 2-bits corresponding to dimension 1 (e.g., a bit value representing dimension 01) in the first indicator xx(Dn), and 2-bits corresponding to the node identity (e.g., bit values representing the node indices 01, 02, 03, or the like) in the second indicator xx(Li) for the location of each of the other three linked nodes 215.

As another example, from the root node 220 (e.g., having a node index of 00) of the two-dimension layer 225, the links to each of the nodes of the one-dimension layers 210 thereof may be encoded by 2-bits for dimension 2 (e.g., a bit value representing dimension 02), 2-bits for dimension 1 (e.g., a bit value representing dimension 01), and 2-bits corresponding to the node identity (e.g., bit values representing the node indices 09, 10, 11, or the like) in the second indicator xx(Li) for the location of each of the other three nodes 215 in each of the dimension ones.

As another example, referring to FIGS. 3 and 10, from the root node 220 (e.g., having a node index of 00) of the three-dimension layer 240, the links to each of the nodes of the one-dimension layers 210 thereof may be encoded by 2-bits for dimension 3 (e.g., a bit value representing dimension 03), 2-bits for dimension 2 (e.g., a bit value representing dimension 02), 2-bits for dimension 1 (e.g., a bit value representing dimension 01), and 2-bits corresponding to the node identity (e.g., bit values representing the node indices 41, 42, 43, or the like) in the second indicator xx(Li) for the location of each of the other three nodes 215 in each of the dimension ones of the three-dimension layer 240. As an illustration, in addition to the examples shown in FIG. 10, the memory node having the node index of 21 of the three-dimension layer 240 shown in FIG. 3 may be encoded by the bit values representing 03_02_01_21.

In some embodiments, still referring to FIGS. 3 and 10, when a root node 245 of one of the two-dimension layers 225 is accessed from the root node 220 of the three-dimension layer 240, a skip value (e.g., 00 or the like) may be encoded for the first indicator xx(Dn) representing dimension 01, and the second indicator xx(Li) may include the corresponding bit values representing the node index of the root node 245 of the corresponding dimension 2 being accessed from the root node 220 of the three-dimension layer 240.

In other words, according to some embodiments of the present disclosure, each of the memory nodes may be accessed, and communications may be routed therebetween, based on the first indicator for each of the dimensions and the second indicator for each of the memory nodes. Further, in some embodiments, a number of hops or links required to access each of the memory nodes from the perspective of (e.g., from the location of) a root memory node may be determined based on the first identifier in the encoding (e.g., the address encoding). As such, a desired size of the memory pool and a suitable path selection therethrough may be determined based on the first identifier and the second identifier of each of the memory nodes, even when different clients (e.g., different applications, workloads, and the like) may have different requirements with respect to the quantity and/or performance (e.g., the latency characteristics) of the memory.

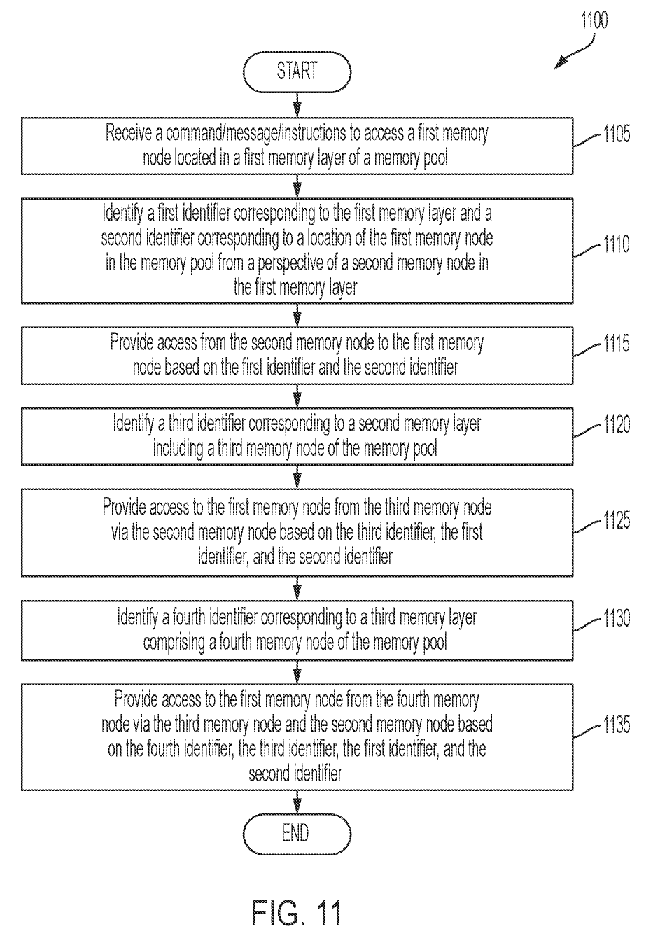

FIG. 11 illustrates a method of providing access to a first memory node of a memory pool according to one or more embodiments of the present disclosure.

For example, FIG. 11 may illustrate a method 1100 for accessing the other nodes 215 of a one-dimension layer 210 from various root nodes 220 of various dimension layers of one or more memory pools. However, the present disclosure is not limited to the sequence or number of the operations of the method 1100 shown in FIG. 11, and can be altered into any desired sequence or number of operations as recognized by a person having ordinary skill in the art. For example, in some embodiments, the order may vary, or the method 1100 may include fewer or additional operations. Further, the operations shown in the method 1100 may be performed by any suitable one of the components or any suitable combination of the components of those of one or more example embodiments described herein. For example, the method 1100 may be performed by any suitable ones of the circuits, switches, controllers, processors, memory devices, logic devices, and the like described above that may require, promote, facilitate, and the like the access to a memory node from another memory node. As such, the method 1100 may be described in more detail with reference to FIG. 11 in terms of a command, a message, a set of instructions, or the like, which may be performed by any suitable ones of the circuits, switches, controllers, processors, memory devices, logic devices, and the like described above, and thus, the present disclosure is not limited to any particular embodiment.

Referring to FIG. 11, the method 1100 may start, and a command/message/instructions may be received to access a first memory node located in a first memory layer of a memory pool at block 1105. As an example, the first memory node may be any of the other memory nodes 215 in a corresponding one-dimension layer. A first identifier corresponding to the first memory layer and a second identifier corresponding to a location of the first memory node in the memory pool from a perspective of (e.g., from a location of) a second memory node in the first memory layer may be identified at block 1110. For example the second memory node may be the root memory node of the corresponding one-dimension layer.

In some embodiments, the first and second identifiers may be identified from the respective bits contained in the command/message/instructions (e.g., in a header field thereof). In other words, the first identifier may be encoded in first bits contained in the command/message/instructions (e.g., in the header field thereof) and the second identifier may be encoded in second bits contained in the command/message/instructions (e.g., in the header field thereof). For example, in some embodiments, the first identifier may be encoded in at least one of the source bits, the destination bits, or the port bits of the header field, or may be encoded in the reserve bits of the header field. In some embodiments, the second identifier may be encoded in the port identifier (e.g., the PID) bits of the header field. Access from the second memory node to the first memory node may be provided based on the first identifier and the second identifier. For example, a message, a packet, or the liked may be facilitated between the first and second memory nodes based on the first and second identifiers with one hop or link latency.

In some embodiments, a third identifier corresponding to a second memory layer including a third memory node of the memory pool may be identified at block 1120, and access to the first memory node from the third memory node via the second memory node may be provided based on the third identifier, the first identifier, and the second identifier at block 1125. For example, in some embodiments, the respective bits contained in the command/message/instructions (e.g., in the header field thereof) may further include dimension information corresponding to a memory node in a two-dimension layer 225. For example, the third memory node may be the root memory node 220 of the two-dimension layer 225. As such, the message, the packet, or the liked may be facilitated from the third memory node to the first memory node through 1 hop or link from the third memory node to the second memory node, and 1 hop or link from the second memory node to the first memory node based on the third identifier, the first identifier, and the second identifier, resulting in a total of a two hop or link latency.

In some embodiments, a fourth identifier corresponding to a third memory layer comprising a fourth memory node of the memory pool may be identified at block 1130, and access to the first memory node from the fourth memory node via the third memory node and the second memory node may be provided based on the fourth identifier, the third identifier, the second identifier, and the first identifier at block 1135. For example, in some embodiments, the respective bits contained in the command/message/instructions (e.g., in the header field thereof) may further include dimension information corresponding to a memory node in a three-dimension layer 240. For example, the fourth memory node may be the root memory node 220 of the three-dimension layer 240. As such, the message, the packet, or the liked may be facilitated from the fourth memory node to the first memory node through 1 hop or link from the fourth memory node to the third memory node, 1 hop or link from the third memory node to the second memory node, and 1 hop or link from the second memory node to the first memory node based on the fourth identifier, the third identifier, the first identifier, and the second identifier, resulting in a total of a three hop or link latency.

In some embodiments, the method 1100 may end, or if the respective bits contained in the command/message/instructions (e.g., in the header field thereof) further include dimension information corresponding to a memory node in an even higher-dimension layer, then the message, the packet, or the liked may be facilitated from the higher-dimension memory node to the first memory node through 1 hop or link from the higher-dimension memory node to the fourth memory node, 1 hop or link from the fourth memory node to the third memory node, 1 hop or link from the third memory node to the second memory node, and 1 hop or link from the second memory node to the first memory node based on the higher-dimension identifier, the fourth identifier, the third identifier, the first identifier, and the second identifier, resulting in a total of a four hop or link latency, or even higher as the dimensions are increased.

The foregoing is illustrative of some embodiments of the present disclosure, and is not to be construed as limiting thereof. When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being "electrically connected" to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” "includes," "including," "has," "have," and "having," when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression "A and/or B" denotes A, B, or A and B. Expressions such as “at least one of,” when preceding a list of elements, modify the entire list of elements and do not modify the individual elements of the list. For example, the expression "at least one of a, b, or c," “at least one of a, b, and c,” and “at least one selected from the group consisting of a, b, and c” indicates only a, only b, only c, both a and b, both a and c, both b and c, all of a, b, and c, or variations thereof.

As used herein, the term "substantially," "about," and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms "use," "using," and "used" may be considered synonymous with the terms "utilize," "utilizing," and "utilized," respectively. Also, the term “exemplary” is intended to refer to an example or illustration.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A system comprising:
a first memory layer comprising:
a first memory node of a memory pool; and
a second memory node of the memory pool, the second memory node being connected to the first memory node by one link in the first memory layer; and
a switch configured to provide access to the first memory node from the second memory node based on:
a first identifier corresponding to the first memory layer; and
a second identifier corresponding to a location of the first memory node in the memory pool.

2. The system of claim 1, wherein the first identifier is encoded in first bits of a message received by the switch, and the second identifier is encoded in second bits of the message received by the switch.

3. The system of claim 2, wherein the first bits and the second bits are encoded in a header field of the message.

4. The system of claim 2, wherein the first bits of the first identifier are encoded in at least one of source bits, destination bits, or port bits of the message, or in reserve bits of the message.

5. The system of claim 1, wherein the second identifier corresponds to a port identifier associated with the first memory node.

6. The system of claim 1, further comprising a second memory layer comprising a third memory node of the memory pool, the third memory node being connected to the second memory node by one link from the second memory layer to the first memory layer,
wherein the switch is further configured to provide access to the first memory node from the third memory node based on:
a third identifier corresponding to the second memory layer;
the first identifier corresponding to the first memory layer; and
the second identifier corresponding to a location of the first memory node in the memory pool.

7. The system of claim 6, wherein the third memory node is connected to the first memory node through the second memory node.

8. The system of claim 6, further comprising a third memory layer comprising a fourth memory node of the memory pool, the fourth memory node being connected to the third memory node by one link from the third memory layer to the second memory layer,
wherein the switch is further configured to provide access to the first memory node from the fourth memory node based on:
a fourth identifier corresponding to the third memory layer;
the third identifier corresponding to the second memory layer;
the first identifier corresponding to the first memory layer; and
the second identifier corresponding to a location of the first memory node in the memory pool.

9. The system of claim 6, further comprising a third memory layer comprising a fourth memory node of the memory pool, the fourth memory node being connected to the third memory node by one link from the third memory layer to the second memory layer,
wherein the fourth memory node is connected to the first memory node through the third memory node and the second memory node.

10. A method comprising:
receiving instructions to access a first memory node located in a first memory layer of a memory pool;
identifying, from the instructions, a first identifier corresponding to the first memory layer and a second identifier corresponding to a location of the first memory node in the memory pool from a location of a second memory node connected to the first memory node by one link in the first memory layer; and
providing access from the second memory node to the first memory node based on the first identifier and the second identifier.

11. The method of claim 10, wherein the first identifier is encoded in first bits contained in the instructions, and the second identifier is encoded in second bits contained in the instructions.

12. The method of claim 11, wherein the first bits of the first identifier are encoded in at least one of source bits, destination bits, or port bits of a header field of the instructions, or encoded in reserve bits of the header field of the instructions.

13. The method of claim 10, wherein the second identifier corresponds to a port identifier associated with the first memory node.

14. The method of claim 10, further comprising:
identifying, from the instructions, a third identifier corresponding to a second memory layer comprising a third memory node of the memory pool, the third memory node being connected to the second memory node by one link from the second memory layer to the first memory layer; and
providing access to the first memory node from the third memory node based on:
the third identifier corresponding to the second memory layer;
the first identifier corresponding to the first memory layer; and
the second identifier corresponding to a location of the first memory node in the memory pool.

15. The method of claim 14, wherein the third memory node accesses the first memory node through the second memory node.

16. The method of claim 10, further comprising:
identifying, from the instructions, a third identifier corresponding to a second memory layer comprising a third memory node of the memory pool, the third memory node being connected to the second memory node by one link from the second memory layer to the first memory layer;
identifying, from the instructions, a fourth identifier corresponding to a third memory layer comprising a fourth memory node of the memory pool, the fourth memory node being connected to the third memory node by one link from the third memory layer to the second memory layer; and
providing access to the first memory node from the fourth memory node based on:
the fourth identifier corresponding to the third memory layer;
the third identifier corresponding to the second memory layer;
the first identifier corresponding to the first memory layer; and
the second identifier corresponding to a location of the first memory node in the memory pool.

17. The method of claim 16, wherein the fourth memory node accesses the first memory node through the third memory node and the second memory node.

18. A system comprising:
a memory pool;
one or more processors connected to the memory pool; and
instructions that, when executed by the one or more processors, cause the one or more processors to:
receive a command to provide access to a first memory node located in a first memory layer of a memory pool;
identify, from the command, a first identifier corresponding to the first memory layer and a second identifier corresponding to a location of the first memory node in the memory pool from a location of a second memory node connected to the first memory node by one link in the first memory layer; and
provide access from the second memory node to the first memory node based on the first identifier and the second identifier,
wherein the first identifier is encoded in first bits of the command, and the second identifier is encoded in second bits of the command.

19. The system of claim 18, wherein the first bits of the first identifier are encoded in at least one of source bits, destination bits, or port bits of a header field of the command, or encoded in reserve bits of the header field of the command.

20. The system of claim 18, wherein the second identifier corresponds to a port identifier associated with the first memory node.
